(19) United States
(12) Patent Application Publication
(10) Pub. No.: US 2017/0164582 A1
(43) Pub. Date: Jun. 15, 2017

(54) PET LEASH HANDLE

(71) Applicant: George Torres, Buffalo, NY (US)

(72) Inventor: George Torres, Buffalo, NY (US)

(21) Appl. No.: 15/335,051

(22) Filed: Oct. 26, 2016

Related U.S. Application Data
(60) Provisional application No. 62/246,159, filed on Oct. 26, 2015.

(51) Int. Cl. A01K 27/00

(52) U.S. Cl. CPC A01K 27/004

(57) ABSTRACT

A pet leash handle having a hard frame, a clip and a leash attachment mechanism. The hard frame forms a body of the pet leash handle and includes a soft grip portion shaped for the comfort of a pet owner's hand. The clip is pivotally attached to the hard frame so as to move between an open position and a closed position. The leash attachment mechanism removably attaches a pet leash to the pet leash handle. The pet leash handle also includes a retractable cord connected to the leash attachment mechanism and allowing for the pet leash to extend and to retract depending on the pet owner's need.

### FIELD OF THE INVENTION

This invention generally relates to dog leash handles attachable to stationary objects.

### BACKGROUND OF THE INVENTION

Local rules often require pet owners to be in complete control of his/her pet in public areas for the safety of the pet as well as the general public. For this reason, animals, specifically dogs, are placed on a leash to maintain control of the animal. In some public and private facilities (e.g., shops, restaurants, hospitals), animals may be completely prohibited. In such instances, a pet owner would typically must secure the pet to a stationary object outside such facility. When using a conventional leash, in order to secure the pet, the owner would first remove the leash from the pet's collar, wrap the leash around the stationary object, loop the leash through the leash handle, and then attach the leash back to the collar. During this procedure, the pet may get agitated, distracted or may resist the process altogether. The pet owner may loose control of his/her animal, thereby placing the animal and the public in danger. Accordingly, there is a need for an improvement on a dog leash.

### SUMMARY OF THE INVENTION

In one of its general aspects, the invention is a pet leash handle having a hard frame, a clip and a leash attachment mechanism. The hard frame forms a body of the pet leash handle and includes a soft grip portion shaped for the comfort of a pet owner's hand. The clip is pivotally attached to the hard frame so as to move between an open position and a closed position. The leash attachment mechanism removably attaches a pet leash to the pet leash handle. The pet leash handle also includes a retractable cord connected to the leash attachment mechanism and allowing for the pet leash to extend and to retract depending on the pet owner's need.

The above aspects, advantages and features are of representative embodiments only. It should be understood that they are not to be considered limitations on the invention as defined by the claims. Additional features and advantages of the invention will become apparent in the following description, from the drawings, and from the claims.

### BRIEF DESCRIPTION OF THE DRAWING

The invention is illustrated by way of example and not limitation and the figures of the accompanying drawings in which like references denote like or corresponding parts, and in which:

FIG. 1 shows a pet leash handle with a retractable cord in its closed position, according to invention principles.

FIG. 2 shows a pet leash handle with a retractable cord in its open position, according to invention principles.

FIG. 3 shows a pet leash handle without a retractable cord in its closed position, according to invention principles.

FIG. 4 shows a pet leash handle without a retractable cord in its open position, according to invention principles.

FIG. 5 shows a detailed view of the pet leash handle with a retractable cord, according to invention principles.

### DETAILED DESCRIPTION OF THE PREFERRED EMBODIMENTS AND THE DRAWINGS

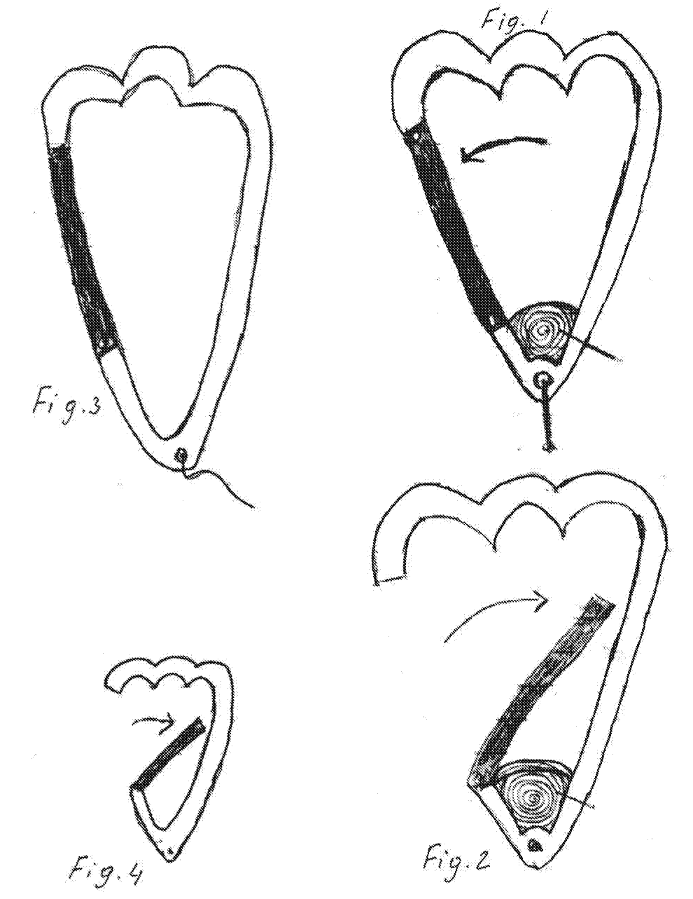

As shown in FIG. 5, in accordance with the preferred embodiment, the leash handle includes a hard frame 1, a soft grip portion 2, a clip 3, a retractable cord 4 and a leash attachment mechanism 5. The hard frame forms the body of the leash handle, and is made of a durable and lightweight material, e.g., plastic or lightweight metal. Soft grip portion 2 is preferably shaped for the comfort of the pet owner's hand, and is made of a comfortable non-slip material. Clip 3 is pivotally attached to the hard frame 1 so as to move between an open position (shown in FIG. 2) and a closed position (shown in FIG. 1). A pet's leash can be removably attached to the leash attachment mechanism 5, which is connected to the retractable cord 4, thereby allowing for the leash to extend and/or to retract depending on the owner's need.

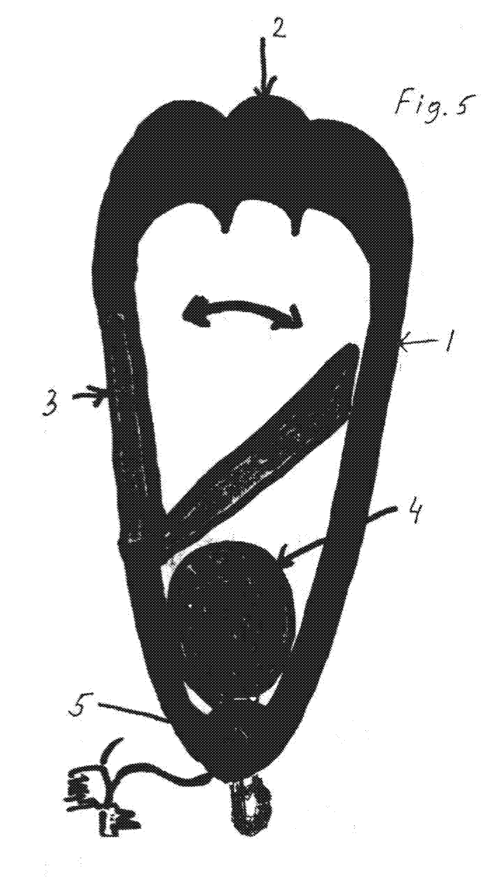

As shown in FIGS. 3-4, in an alternative embodiment, the leash handle can be provided without the retractable cord. In this embodiment, the leash attachment mechanism 5 is connected directly to the hard frame 1, or formed as part thereof, and the pet leash is connected to the leash attachment mechanism.

In use, when the pet owner needs to secure its pet to a stationary object, depending on the diameter of the stationary object, the owner will open the clip and either attach it directly to a small-diameter stationary object (e.g., a fence or a pole) or wrap the leash around a larger-diameter stationary object (e.g., a tree), insert the leash into the open handle and clasp the clip on the leash, locking the leash within the handle. During the entire process of securing the pet, at least one hand of the pet owner remains on the leash allowing the pet owner to maintain complete control over the animal.

One of the advantages of the presently disclosed leash handle is that the handle becomes a clasp or a lock making it easy to secure the pet to a stationary object without detaching the leash from the pet's collar. Thus, the present invention allows for a way to secure the pet without endangering the pet or the general public.

While there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention.

I claim as follows:

1. A pet leash handle comprising:
a hard frame forming a body of the pet leash handle, said hard frame comprising a soft grip portion shaped for the comfort of a pet owner's hand;
a clip pivotally attached to said hard frame so as to move between an open position and a closed position; and
a leash attachment mechanism removably attaching a pet leash to said pet leash handle.

2. The pet leash handle of claim 1, further comprising a retractable cord connected to the leash attachment mechanism and allowing for the pet leash to extend and to retract depending on the pet owner's need.

3. The pet leash handle of claim 1 wherein said hard frame is made of a durable and lightweight material.

4. The pet leash handle of claim 1 wherein said soft grip portion 2 is made of a comfortable non-slip material.
